(19) United States
(12) Patent Application Publication
(10) Pub. No.: US 2007/0172631 A1
(43) Pub. Date: Jul. 26, 2007

(54) Multichamber dividing element

(75) Inventor: Patrick Hugenholtz, Sint-Martens-Latern (BE)

Correspondence Address: HARNESS, DICKEY & PIERCE, P.L.C., P.O. BOX 828, BLOOMFIELD HILLS, MI, 48303, US

(73) Assignee: Conteyor Multibag Systems N.V., Merelbeke (BE)

(21) Appl. No.: 10/590,372

(22) PCT Filed: Feb. 24, 2005
(86) PCT No.: PCT/EP05/50777

§ 371 Date: Apr. 18, 2007

(30) Foreign Application Priority Data
Feb. 24, 2004 (DE) 10 2004 008 969.8

(51) Int. Cl. B32B 3/12

(52) U.S. Cl. 428/116; 156/197; 156/291

(57) ABSTRACT

The invention relates to a multi-chambered dividing element (1) for a transport container (2) made of a plurality of tracks (3) which are layered in a manner adjacent to each other or on top of each other. Adjacent tracks are connected to each other by means of common contact surfaces (4) at predetermined distances, the tracks (3) are made of flexible material, and the common contact surfaces (4) or two given, directly connected tracks (3) are arranged in an offset manner in relation to the contact surfaces (4) of each of said tricks (3) with one respective subsequent track on a track plane, such that the dividing element (1) can be arranged, hung or tensed in such a manner that it comprises flexible chambers (5) in the arranged, hung or tensed state. The invention also relates to a method for the production of said type of dividing element. According to the invention, initially the two tracks made of flexible material are connected to each other by gluing, sewing, soldering or by placing profiles over common contact surfaces on a plurality of points distributed over the surface of the tracks whereupon they are layered in a flat manner in the form of any specific number of said tracks, wherein each additional track is connected to the track by gluing, sewing, soldering or placing profiles over common contact surfaces on a plurality of points distributed over the surface of the tracks whereon they are layered thereon.

The present invention relates to a multichamber dividing element for transport containers consisting of several sheets stacked vertically or horizontally, wherein adjacent sheets are connected to each other via common contact surfaces at defined intervals.

The transportation of unit loads is becoming increasingly important. This is due for one thing to the ever more pronounced tendency for different production sites of a product line to specialize in the manufacture of pure intermediate products or in the final assembly of these intermediate products. For another, the volume of transported unit loads continues to increase dramatically because, with the progressive globalization of the world economy, the above-mentioned production sites need not necessarily be located in one region, but may be widely distributed over different countries and continents.

The demands made of transport containers carrying unit loads are great. First comes the protection of the corresponding cargo from damage as a result of transportation. Furthermore it is desirable that the corresponding transport containers are as light as possible while retaining their required stability. In order to be able to use the most varied transport containers, such as e.g. boxes, cartons, crates or containers, for the transportation of unit loads, it is necessary to divide the space in these containers into smaller spaces which can house the corresponding unit loads. This division of the interior of transport containers into smaller compartments is achieved by so-called dividing elements. Such dividing elements can be e.g. walls incorporated into the transport container which are thus a fixed constituent of the transport container. In addition, there are dividing elements which are not a fixed constituent of the transport container, but can be fitted as desired into a transport container. Such dividing elements include dividing walls made of e.g. cardboard or corrugated board, wherein the material is trimmed and/or folded so that it divides the transport space of the transport container into several small spaces or chambers. Such a division is often also achieved by fitting together the above-named cardboard or corrugated-board walls. In the case of some dividing elements from the state of the art, the separating material is both folded and fitted together. Corrugated plastic or solid plastic is also known as an alternative separating material to cardboard and corrugated board.

The disadvantages of cardboard and board are their relatively low stability and their high fragility when exposed to high mechanical stress. Accordingly, cardboard or board dividing elements are usually single-trip items which must be disposed of after the unit loads have been transported. In addition, these materials are extremely moisture-sensitive and suffer a marked loss of stability when exposed to moisture. On the other hand, moisture does not usually pose a problem when using plastic and corrugated plastic. Although corrugated plastic and in particular solid plastic are in principle reusable more often than dividing elements made of cardboard or corrugated board, they also have the disadvantage that they are generally more inflexible, particularly so in the case of solid plastic. With all the dividing elements known from the state of the art, the dimensions of the dividing elements are matched precisely to the dimensions of the corresponding transport containers whose interiors they are intended to divide. Correspondingly, as a rule the use of a dividing element for a specific transport container is possible only if this dividing element has been made specially for use in said transport container.

To overcome the above-named disadvantages of customary dividing elements, it is therefore the object of the present invention to provide a dividing element optimized in respect of stability, carrying strength and tensile strength which is light, watertight and flexibly usable in different transport containers, and which can be reused repeatedly. A further aspect of the object of the present invention is to provide as fast and efficient as possible a production process for the production of dividing elements according to the invention.

The above-named object of the invention is achieved by a multichamber dividing element for transport containers consisting of several sheets stacked vertically or horizontally, wherein adjacent sheets are connected to each other via common contact surfaces at defined intervals, wherein the dividing element [is] also characterized in that the sheets are made of flexible material, and in that the common contact surfaces of two given, directly connected sheets are arranged offset in the sheet plane vis-à-vis the contact surfaces of one of these sheets with a respective next sheet (if present), with the result that the dividing element can be erected, suspended or stretched such that it has flexible chambers when erected, suspended or stretched.

As a result of using flexible material, a dividing element according to the invention is not as rigid as customary dividing elements. Consequently, the insertion elements according to the invention are more versatile and can also be quickly and easily adapted as required to different transport containers. In addition, these dividing elements of flexible material can be folded up after transportation and can be reused at any time to divide a transport container. An important feature of the chambers formed by the dividing element according to the invention is that they do not necessarily have a fixed shape, i.e. they can be e.g. circular or ellipsoidal or more likely assume the shape of a rhombus or rectangle. This depends primarily on the materials used and if applicable the stress under which the dividing element is erected, suspended or stretched. In addition, also decisive for this is how the contact surfaces are designed and arranged relative to one another. The variable shape of the chambers formed by the dividing element makes it possible to also incorporate into these chambers unit loads whose shape does not necessarily correspond to the shape of the chambers in the erected, suspended or stretched, non-loaded state. In these cases, the shape of the chambers can adapt somewhat to the shape of the unit load or unit loads, which illustrates the versatility of a dividing element according to the invention.

The common contact surfaces via which the two given sheets are directly connected can be e.g. punctiform, areal or striated. Particularly preferred are contact surfaces which are substantially contact strips that are continuous or perforated only in places and are arranged parallel at defined intervals and extend substantially over one dimension of the sheet surface. The greatest possible stability and fixation are achieved, compared with e.g. punctiform contact surfaces, because the contact surfaces extend substantially over the whole length of one dimension of the sheet surface. These contact strips are preferably arranged parallel to one another at defined intervals. The optimum chamber volume for a given material outlay is achieved by an offset arrangement of the contact strips in successive contact strip planes. A particularly preferred embodiment of the present invention is therefore characterized in that the contact strips of one contact strip plane between two given, directly connected sheets are arranged offset in the sheet plane across the longitudinal extension of the contact strips vis-à-vis the contact strips of a contact strip plane of one of these sheets with a respective next sheet (if present). It is particularly advantageous if the arrangement here is chosen so that the contact strips of two adjacent contact strip planes are arranged offset by half the distance between the contact strips of one plane. A symmetrical arrangement of the chambers is thus achieved which extends over the various planes of a dividing element according to the invention.

The above-named common contact surfaces between adjacent sheets are formed in different embodiments of the invention by gluing, sewing or welding of the sheets to one another. In alternative embodiments, the common contact surfaces are formed by attaching profiles, wherein adjacent sheets are held together by the fitted profiles. In further embodiments, at least some of the sheets are connected to one another to form common contact surfaces by rivets, for example hollow rivets, by double-sided adhesive tape or Velcro fastening, and in particular embodiments the sheets are connected to one another to form common contact surfaces by buttons, pushbuttons or hooks and eyes. In particularly preferred embodiments, combinations of the different fixing techniques named above are advantageously used.

The sheets are connected to one another via the common contact surfaces, wherein the choice of method for connecting the sheets depends firstly on the materials used to produce dividing elements according to the invention and how stable the connection between the sheets is to be, and secondly on whether the connection is to be permanent or reversible.

Gluing of the sheets is advantageous as almost all of the materials that can be used for sheets of the invention can be connected to one another with adhesive, and the gluing process can be carried out particularly rapidly and cost-favourably.

Welding of the sheets is also rapid and cost-favourable and is moreover also advantageous because dividing elements result that consist substantially of one material, because connection means made of other materials, such as for example adhesive or yarn, are not essential to form contact surfaces between the sheets. Products that are made of one material can be more easily recycled, i.e. reused. On the other hand, products that are made of several materials must be laboriously separated into their individual constituents, or main constituents separated from minor constituents, during recycling. A particularly preferred welding process for connecting sheets is ultrasonic welding.

The particular advantage of sewing the sheets at the contact points is that a particularly stable connection between the sheets is thereby obtained. This is also the case if the sheets are connected by rivets. A particularly secure connection is of major importance above all if the contact points of the dividing element are exposed to very high tensile stresses when used for the intended purpose in a transport container. Although this applies mainly to dividing elements that are suspended or stretched in the transport container under greater stress, it also applies to dividing elements that are merely erected in a transport container, as considerable tensile forces also act on the contact points between the sheets as a result of movements of the cargo in the chambers during transportation.

Connecting of dividing element sheets via double-sided adhesive tape, Velcro fastening, by buttons, pushbuttons or hooks and eyes is preferred with the dividing elements according to the invention where at least some of the sheets are releasably connected. In this way, a dividing element can be matched flexibly to the size of a transport container, wherein either individual sheets are connected to each other to form one dividing element or individual sheets are attached to a predetermined dividing element in order to enlarge this dividing element, or by joining several small dividing elements together to form one large dividing element. In particularly preferred embodiments, the above-named possibilities for releasable connection of sheets are advantageously combined. Thus in particular connection techniques can advantageously be combined one of which in particular makes possible the rapid and uncomplicated connecting of sheets (e.g. double-sided adhesive tape, Velcro tape, pushbuttons) and the other additionally provides a connection that [is] more stable vis-à-vis increased tensile forces (e.g. hooks and eyes, buttons).

The flexible material used for the sheets of the dividing elements includes i.a. flexible plastics and elastic materials, wherein elastic plastics are preferably used. The use of elastic material provides an additional advantage in that the shape of the chambers can adapt even better to the unit loads. The dividing element according to the present invention thereby becomes more flexible overall and can consequently be more easily stretched as the elastic material can give somewhat and also expand. Preferred flexible materials are foils, nonwovens (e.g. felt fabrics, nonwoven fleeces), laminates, coated woven fabrics, woven fabrics and interlaid scrim. Particularly preferred flexible materials are industrial-grade textiles (e.g. knitted fabric, warp-knitted fabric and biaxial structures). Industrial-grade textiles have a high load-bearing capacity, are very stable and tear-resistant and yet weigh exceptionally little. The use of industrial-grade textiles whose textile meshes are arranged such the meshes can slide in and out of one another is particularly advantageous. As a result of the sliding in and out, a corresponding industrial-grade textile gains additional elasticity and can above all be folded up when not stretched in order to save space. Materials that do not become electrostatically charged are particularly preferred.

Materials that are approximately 0.05-1 mm thick are preferably used for the sheets, wherein particularly preferred materials are approximately 0.1-0.5 mm thick. In particular materials less than 0.3 mm thick are preferred, such as for example textile materials that are less than 0.3 mm thick.

Particularly preferred materials are extremely watertight and resistant to different liquids, such as e.g. aqueous solutions, emulsions or oils. By watertight is meant here that the material is resistant both to high air humidity and to direct contact with water, wherein the said contact can be relatively short (e.g. rain shower) or much longer (e.g. flooding of storage spaces). Watertight dividing elements according to the present invention also additionally include dividing elements that are suitable for transporting moist or liquid-exuding products. By liquid-exuding products are meant here among others also products that exude lubricants or fats. In addition, dividing elements according to the invention can also advantageously be used for storing or transporting goods generally in water, aqueous solutions or other liquids.

Decisive in selecting the materials for the production of a dividing element according to the invention is that the material allows repeated insertion, suspension or stretching and refolding of the dividing element. In particular compared with dividing elements made of cardboard, corrugated board and plastic, a corresponding dividing element according to the invention is preferably very flexible, designed to withstand permanent stress and continually reusable.

In principle, the chambers of a dividing element according to the invention need not all be the same size. This offers the possibility of also fitting unit loads of different sizes into one dividing element for simultaneous transportation. However, depending on the unit load to be transported, it may be advantageous if at least the chambers of the dividing element which lie between two given sheets are substantially the same size. It is actually particularly preferred that all the chambers of the dividing element are substantially the same size. However, in an alternative embodiment, the outermost chambers which lie between two sheets are somewhat smaller than the other sheets. In this way, material is saved at the ends of the sheets, wherein the chamber size can be suitably adapted to the size of the cargo when using flexible material. In addition, when such dividing elements according to the invention are used in transport containers, less valuable transport space is also used. In further preferred embodiments, one or more chambers which lie between two sheets differ in size from the other chambers. The so-called cutting areas, which are provided at the same point in each case on the vertically stacked sheets, preferably lie in the area of these chambers. Vertically stacked sheets are then cut in these thus-provided areas, whereby several separate dividing elements form. The advantages of dividing elements with cutting areas will be discussed in more detail below.

A dividing element according to the invention is preferably dimensioned such that it can be erected, suspended or stretched in a corresponding transport frame or transport container. In this way, the interior of the transport frame or container is divided into several chambers by the dividing element. The dividing element is erected, suspended or stretched between the walls or frame elements of the transport container, wherein it is fixed to same at certain points as required, wherein the fixing can be carried out as required to at least one wall or more walls or one or more frame elements of the transport container. With a substantially rectangular transport container, the dividing element is preferably fixed to two opposite walls, wall sections or frame elements. A dividing element made of at least semi-rigid but still flexible material can also be fitted into a transport container without fixing, wherein the sheets stand substantially vertical on the floor of the transport container. However it is preferred to also at least partly connect an erectable dividing element securely to the transport container.

To fix a dividing element to a transport container, some embodiments of the invention have permanent connection means and others releasable connection means. In embodiments with a permanent connection between dividing element and transport container, the connection is preferably formed by gluing, sewing, tacking or via nails, screws or rivets. In embodiments with a releasable connection between dividing element and transport container, the connection is preferably formed via double-sided adhesive tape or Velcro fastening, by buttons, pushbuttons or hooks and eyes, wherein combinations of the different fixing techniques are also covered by the concept of the invention.

In the case of releasable connections, means such as double-sided adhesive tape are preferred, wherein these means are preferably punctiform, areal or striated. Particularly preferred are several connection surfaces which are substantially circular. The connection surface or connection surfaces are preferably arranged on an outer sheet at the end near the edge of the sheet which borders the openings of the outer chambers. Furthermore it is preferred if in addition one or more connection surfaces are also provided on the opposite edge of the sheet.

Particularly preferred is the fixing of a dividing element in a transport container using Velcro fastenings, wherein the hook side of the Velcro fastening is attached to the transport container and the loop side of the Velcro fastening is attached to the dividing element. The Velcro fastening can be formed substantially over the full surface or just sections of the contact surface between dividing element and transport container.

In a particularly preferred embodiment of the invention, the hook side of the Velcro fastening is provided in the form of the corresponding side of a Velcro tape on an inside wall or on the inside of a frame element of a transport container, wherein this Velcro tape side extends substantially parallel to the floor plane of the transport container over the wall/frame element, and preferably substantially over the whole longitudinal extent of the inside wall or interior of the frame element. On the two outermost sheets of a dividing element which can be inserted into this transport container provided with the hook-side Velcro tape, the loop side of the Velcro fastening is preferably provided only in sections at certain suitable points. Particularly preferably, the sections in which the loop side is provided are arranged substantially central relative to two adjacent contact surfaces which the outer sheet has with its respective adjacent sheet. In this way, when stretching or suspending the dividing element in the transport container(s), uniform chambers are also formed between the outermost sheet and its adjacent sheet, provided the loop-side sections are connected at appropriate intervals to the hook-side Velcro tape on the transport container. The appropriate interval is calculated from the distance between the contact surfaces and the width of the loop-side sections. In general, the ratio can be expressed such that the loop sections are preferably connected to the hook-side Velcro tape such that the distance between the centre points of the loop sections corresponds substantially to the distance between the contact surfaces between the outermost and adjacent sheets when stretched. To facilitate the rapid stretching or suspension while observing the appropriate distances, in a preferred embodiment the corresponding areas are marked on the hook-side Velcro tape or else the hook-side Velcro tape is provided only in sections, i.e. in the corresponding areas.

The principle according to the invention of connecting a flexible dividing element to a transport container or transport frame via Velcro fastenings can also be applied to dividing elements whose sheets are connected to each other via connectors, i.e. have no direct connection via contact surfaces.

In preferred embodiments of the invention, the dimensions of a transport container and at least two dividing elements are matched to each other such that two or more dividing elements according to the invention occupy parts of the transport container volume when stretched, with the result that two or more dividing elements can be stretched into one transport container. The at least two dividing elements are arranged either on top of or beside each other. Particularly preferably, the at least two dividing elements are arranged partly on top of and partly beside each other. Separators made of semi-rigid plastic or of cardboard are preferably provided between two dividing elements arranged on top of each other. Dividing elements arranged beside each other are preferably releasably connected to each other, preferably by double-sided adhesive tape, Velcro fastening, buttons, pushbuttons or hooks and eyes. In particularly preferred embodiments, the dividing elements are connected to each other such that chambers form between the common contact surfaces, the structure of which preferably substantially corresponds to the chambers of the dividing elements joined to each other.

In a particular embodiment of the present invention, the interior of a transport container or frame has a substantially rectangular starting surface measuring X by Y. This transport container has an internal dimension (height) Z substantially perpendicular to this surface. The width of the sheets of the dividing element for such a transport container is substantially less than or equal to dimension Z. When erected, suspended or stretched, a corresponding dividing element extends perpendicular to the sheet surface preferably over a surface that corresponds substantially to the surface X by Y or is slightly smaller than same. This dividing element is thus dimensioned such that the dividing element can be erected, suspended or stretched into the transport container, wherein the desired chambers advantageously form upon insertion, suspension or stretching. The stretching or separation of the sheets is carried out for example in Y direction, while the sheets (before separation) extend in X direction (and naturally also in Z direction).

Particularly preferably, X is then chosen approximately ⅕ to ⅓ shorter than Y, whereby as a rule the length of the sheets of the slackened or folded-up dividing element is less than Y. The advantage is that the unloaded dividing element can be stored or transported pushed together in the transport container with no need to roll up or bend the dividing element. Depending on the material used, this can be desirable in order to e.g. spare the material. In this way, several pushed-together dividing elements can be stored or transported in one transport container in space-saving manner. The other transport containers the dividing elements of which are housed in a transport container in the above-named manner can optionally also be foldable and thus stored or transported in space-saving manner. The width of the sheets is also preferably chosen to be less than X. In this case, a pushed-together dividing element according to the present invention extends substantially over a surface XY and can accordingly be stored or transported lying on the surface XY of the interior of a transport container. Here also, several pushed-together dividing elements can again be stored or transported vertically stacked in one transport container. Alternatively, in each case only one or a few slackened or folded-up dividing elements can also be placed into a transport container. In this case, e.g. hinge-like elements which make possible a folding-in of the walls onto the surface XY could be provided in the walls or frame elements of a corresponding transport container, or the walls or frame elements could be dismantled for storage or transportation and laid out on the surface XY.

In order to also selectively give the dividing element stability in addition to high flexibility, in particular embodiments reinforcements are provided in at least one dimension in the sheet plane. Such reinforcements can be e.g. profiles made of plastic or other at least semi-rigid materials that are worked into the sheets or applied to the sheets. For example, in particular embodiments, profiles made of plastic, metal or wood are introduced into sheet loops, glued onto the sheets or sewn onto the sheets as reinforcements. In further embodiments, fibre materials which increase the tensile strength of the sheets are provided as alternative or supplementary reinforcements in, on or at the sections of the sheets which are exposed to particularly high tensile forces when dividing elements are used for the intended purpose. In preferred embodiments, such reinforcement means are provided in two different dimensions of the sheet plane. The reinforcement materials are preferably flexible, wherein materials that can expand by varying amounts depending on external conditions, such as e.g. materials that expand or contract depending on the temperature, are particularly preferred.

A process for producing a dividing element according to the present invention is characterized in that firstly two sheets of flexible material are areally connected to each other via common contact surfaces, wherein areally connected means that the sheets are connected to each other at a large number of points distributed over the surface of the sheets. The common contact surfaces can be formed here by gluing, sewing or welding or by connecting adjacent sheets via profiled strips. In a subsequent step of the process, one or any number of further sheets are stacked areally onto one of the sheets or both sheets. Each further stacked sheet is connected to the sheet onto which it is stacked by gluing, sewing or welding or by attaching profiled strips.

This process is described below in somewhat more detail by way of example for sheets connected to one another for gluing. Adhesive is applied pointwise at defined and preferably regular intervals to the top of a first sheet of flexible material. In a second step, a second sheet dimensioned according to the first sheets is laid onto the top of the first sheet. The second sheet is preferably to be pressed onto the first sheet after laying or while laying. In the following step, adhesive is applied pointwise at defined or preferably regular intervals to the top of the second sheet, wherein the adhesive dots applied in this step are offset vis-à-vis the adhesive dots that were applied to the first sheet. A third sheet dimensioned according to the previous sheets is then laid onto the top of the second sheet. Here also, it is preferred to simultaneously or subsequently press the third sheet onto the second sheet. Adhesive is then re-applied pointwise as required at defined or preferably regular intervals to the top of this third sheet. These adhesive dots are then re-applied such that they are again offset vis-à-vis the adhesive dots of the second sheet, e.g. as the adhesive dots on the first sheet are arranged. This procedure can be repeated as often as required by vertically stacking any number of layers in this way and gluing them together, wherein in a preferred embodiment of the invention, the adhesive dots or other forms of contact surfaces are arranged such that the contact surfaces of an nth sheet are arranged like the contact surfaces of a first sheet, etc.

In further preferred embodiments, the adhesive dots applied to the odd-numbered sheets are the same as one another and offset vis-à-vis the adhesive dots applied to the even-numbered sheets.

The adhesive dots applied to the even-numbered sheets are then in turn the same as one another. If the sheets are not connected to one another by gluing but by welding or sewing the process is somewhat different, as firstly a first sheet of flexible material must be introduced first onto which a correspondingly dimensioned second sheet is laid. The pointwise welding or sewing of the first sheet to the second is then carried out at defined or preferably regular intervals. After laying on a third sheet dimensioned according to the previous sheets onto the top of the second sheet, the third sheet is welded or sewn pointwise to the second sheet, wherein the welds or seams arranged at defined or preferably regular intervals are offset vis-à-vis the welds or seams between the first and second sheets. Here also, any desired number of layers can again be welded or sewn together in this way. For this, in each case the laid-on sheet is welded or sewn to the sheet onto which it has been laid. This process principle named in this paragraph also applies when the sheets are connected to one another via profiles, e.g. profiled strips.

The contact surfaces which lie at the ends of the sheets preferably expand less far than the contact surfaces in between. In this way, material is saved at the ends of the sheets, in particular in the case of dividing elements with relatively broad contact surfaces, and less valuable transport space is also used when such dividing elements according to the invention are used in transport containers. With further preferred embodiments of the process according to the invention, so-called cutting areas are provided at appropriate points and optionally at appropriate intervals on the stacked sheets. The cutting areas are provided either by the somewhat broader contact surfaces forming in this area or by providing for example two contact strips arranged in parallel a relatively short distance apart. Stacked sheets can then be cut in the thus-provided areas, whereby several separate dividing elements form. In this way, several dividing elements can be made simultaneously in order to then be cut in a downstream process. In addition, the client has the possibility to subsequently form several small dividing elements from one large one, if desired.

In principle, the precise procedure and the direction in which the contact points are individually applied are unimportant. The most obvious is the application of contact means or the bringing of the sheets into contact by a suitable device which moves over a sheet or over the sheets, wherein the direction in which such a device moves over the sheet or sheets is unimportant, as this is defined by the arrangement according to the invention of the contact points.

A process according to the invention in which a fixing device for gluing, welding or sewing the sheets or for applying profiles to the sheets is stationary, and a holding device for retaining the sheet or the stacked sheets can be moved back and forth across the longitudinal axis of the fixing device and sideways parallel to the longitudinal axis of the fixing device, is particularly advantageous.

As means for applying contact means or for bringing the sheets into contact, one embodiment of a device for carrying out the process according to the invention has a roll which comes into contact with a sheet to be processed. With such a roll, for example, adhesive can be suitably applied to the sheet. An alternative embodiment of a device for carrying out the process according to the invention has single, small rolls or nozzles arranged side-by-side for applying adhesive. With corresponding devices, the distances between the contact surfaces can be varied more flexibly. In a further embodiment, a welding mill with a suitable profile is used, wherein the profile of the welding mill corresponds to the contact surface pattern of the sheets. In an alternative embodiment to this, single welding wheels arranged side-by-side are provided, the width of which corresponds substantially to the width of the contact surfaces to be formed. With such devices, the distances between the contact surfaces can again be varied more flexibly, as with yet another embodiment in which, to form the contact surfaces, single welding stamps are provided arranged side-by-side which are dimensioned according to the dimensions of the contact surfaces. In yet another embodiment, the device has means arranged side-by-side at intervals for the sewing of sheets.

The dividing elements according to the invention which have been produced using one of the processes according to the present invention, can advantageously be used for transporting heavy or sharp-edged unit loads or for transporting moist or liquid-exuding cargo. In addition, the corresponding dividing elements are also advantageous for transporting other unit loads when air humidity is high during transportation or contact with water is not unlikely or the transportation or storage takes place in water, aqueous solutions or other liquids such as suspensions or oils.

The features listed in the above description of embodiments of the present invention can all be freely combined with each other, wherein the advantages of the corresponding feature combinations follow for a person skilled in the art from the combination and also the object underlying a special embodiment. This also applies to the features of further advantageous embodiments of the present invention, which are illustrated by way of example with the help of the following figures. There are shown in:

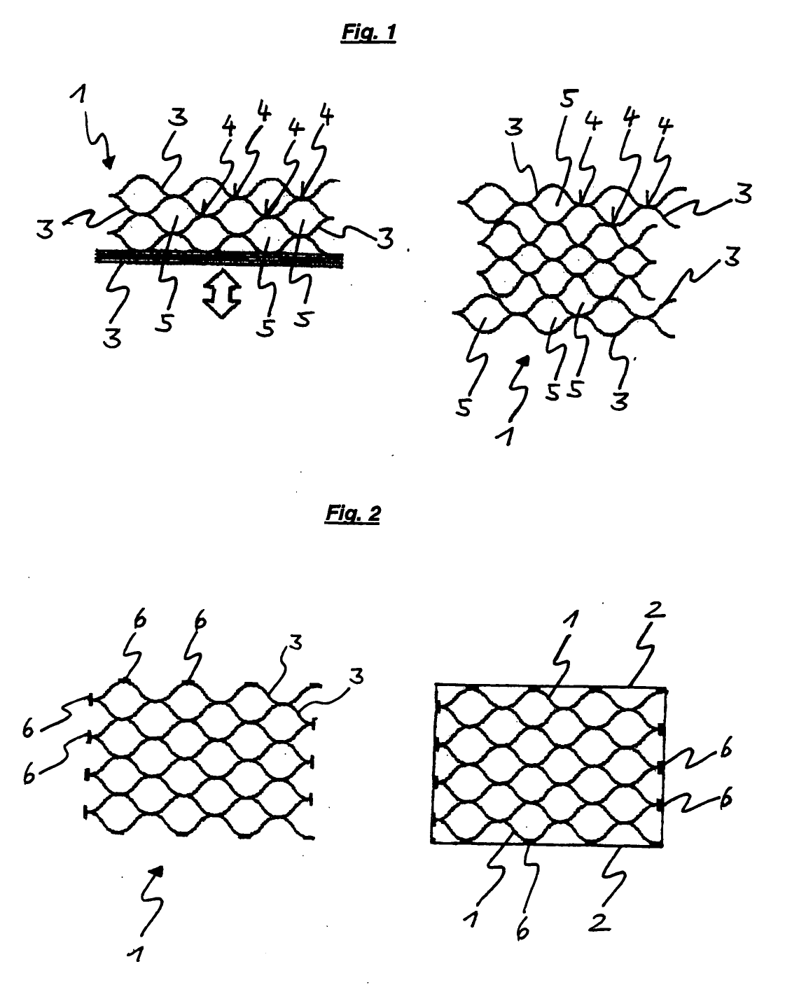

FIG. 1 a plan view from above of a multichamber dividing element which is extended horizontally,

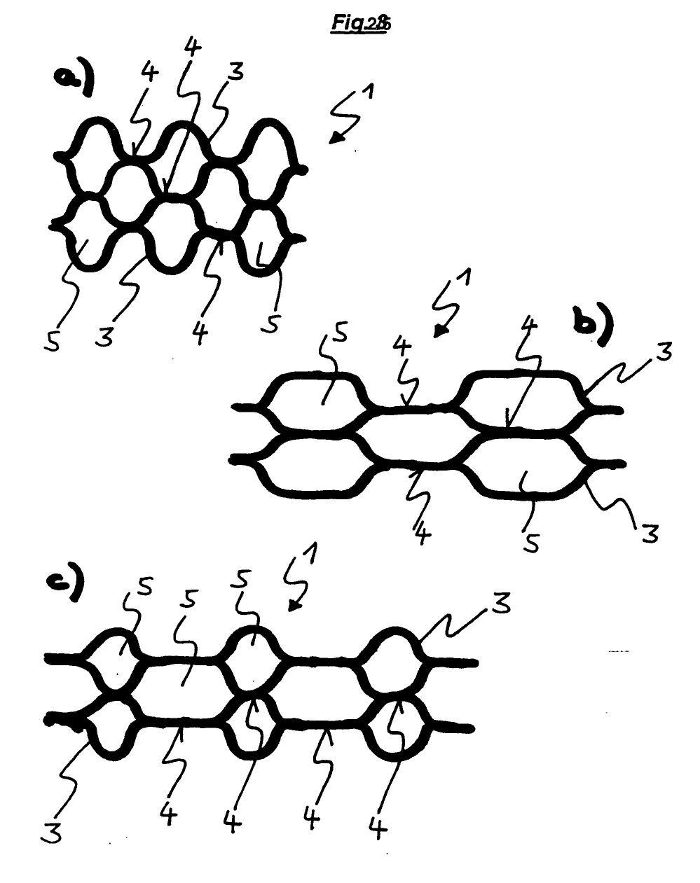

FIG. 2 a plan view from above of a multichamber dividing element according to the invention which has been extended horizontally without (left) and with (right) associated transport container,

FIGS. 3A-C three embodiments of multichamber dividing elements with contact surfaces of different widths between the flexible sheets in plan view from above,

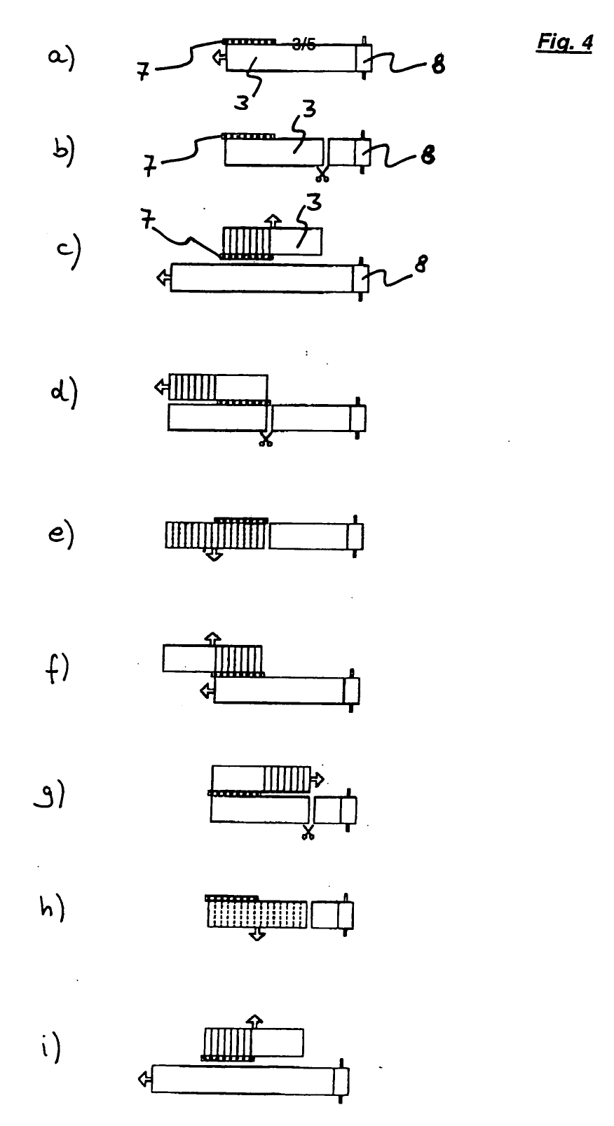

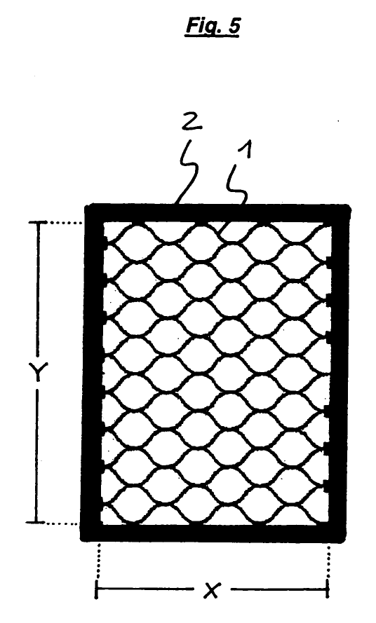

FIGS. 4A-I a schematic representation of a process for the production of a multichamber dividing element according to the invention,

FIG. 5 a plan view from above of a multichamber dividing element according to the invention erected or suspended or stretched into a corresponding transport container, and

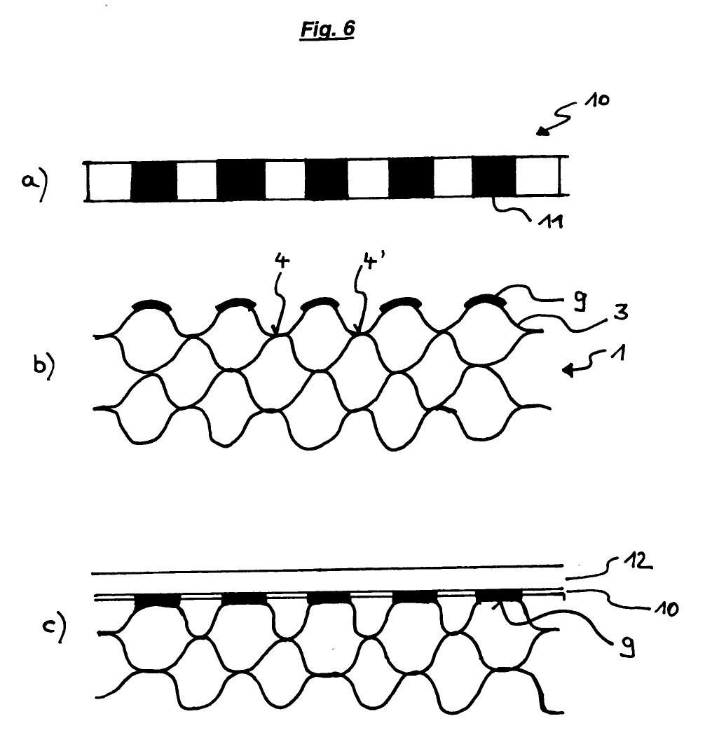

FIG. 6 a plan view from above of a multichamber dividing element with the loop side of a Velcro strip fastener provided sectionwise (b), a top view from the side of the corresponding hook-side Velcro tape (a) which is provided for securing the dividing element to the inside wall of a transport container, and a plan view from above of the multichamber dividing element connected to the inside wall of the transport container (c).

FIG. 1 shows how a multichamber dividing element 1 according to the invention is progressively unfolded or stretched. The drawing is to be understood such that when the dividing element is unfolded or pulled apart horizontally, the drawing is a plan view from above of the dividing element. It can be seen on the left-hand side of FIG. 1 that in this state not all the sheets 3 are as yet unfolded. However, the top four sheets 3 in the drawing are already opened out and, because they are connected to one another at common contact surfaces 4, form three rows of substantially circular to elliptical chambers 5. On the right-hand side of FIG. 1, the dividing element 1 is almost fully unfolded, and seven rows of chambers 5 can be seen which are formed by the sheets 3, because adjacent sheets 3 are each connected to one another via common contact surfaces 4.

A dividing element 1 which is fully unfolded or stretched can be seen in FIG. 2. Fixing elements made of adhesive tape and/or Velcro tape 6, via which the dividing element 1 can be fixed in a transport container 2 (right-hand side of FIG. 2), are located at the outermost points of the sheets 3.

In FIGS. 3A-C, three different embodiments of dividing elements 1 are shown, wherein they differ in that the contact surfaces 4 via which adjacent sheets 3 are connected to one another are formed with different widths. In FIG. 3A, the chosen width of the contact surfaces 4 is such that when the dividing element 1 is unfolded the sheets 3 form substantially circular to elliptical chambers 5. In FIG. 3B on the other hand, the chosen width of the contact surfaces 4 is somewhat greater, the effect of which is that the width of the chambers 5 formed by the sheets 3 also increases. FIG. 3C shows a combination of the embodiments of FIGS. 3A and 3B. For this, the width of the contact surfaces 4 from FIG. 3A and the width of the contact surfaces 4 from FIG. 3B were chosen alternately when designing the width of the contact surfaces 4 of successive sheets 3. Such a dividing element 1 has chambers 5 of different sizes when erected, suspended or stretched.

The schematic drawings in FIGS. 4A-I show a process for producing a dividing element according to the present invention. In FIG. 4A, a section of sheet 3 is unrolled from a roll 8 in the direction of a fixing device 7. FIG. 4B shows how a section of sheet 3 is cut off from the roll 8. This section of sheet 3 is fixed onto a holding device (not shown). As shown in FIG. 4C, this holding device moves upwards with the sheet 3 under the fixing device 7, wherein the latter applies continuous contact strips of adhesive to the sheet at defined intervals. Simultaneously a further section of sheet is unrolled from the roll 8 in the direction of the fixing device 7. In FIG. 4D, a section of sheet 3 unrolled from the roll 8 is cut off. Simultaneously the sheet 3, one half of which is provided with contact strips of adhesive, is transported by half of its length to the left. It can then be seen in FIG. 4E that the sheet 3, one half of which is provided with contact strips, is again passed under the fixing device 7, wherein the latter applies adhesive strips to the half of the sheet 3 not provided with contact strips. The sheet 3, now provided over its whole width with adhesive strips at defined intervals, is located under the sheet 3 unrolled from the roll 8 in FIG. 4C. This sheet, not previously provided with adhesive, is lowered onto the sheet already provided fully with adhesive and pressed onto same. The holding device is then moved right or left by half the distance between the contact strips applied to the first sheet. Accordingly, as shown in FIG. 4F, the contact strips are applied to the top of the second sheet 3 offset by this same half of the distance between the contact strips applied to the first sheet 3, while the holding device with the two sheets is passed under the fixing device 7. It can likewise be seen from FIG. 4F that a section of sheet 3 is again unrolled from the roll 8. This section of sheet 3 is cut off from the roll 8 in FIG. 4G. At the same time, the holding device moves to the right by half the width of sheet 3. Then (FIG. 4H) the holding device with the two sheets moves under the fixing device 7, wherein the adhesive strips are applied to the second half of the second sheet. Once this has happened, the holding device with the two sheets again moves by half the distance between the contact strips back into the starting position shown in FIG. 4A. After the third sheet has been lowered and pressed onto the top of the second sheet, the holding device with the three sheets again moves under the fixing device 7 (FIG. 4I). The procedure shown in FIG. 4I corresponds substantially to the procedures already explained in FIG. 4C. The only difference is that the adhesive strips are applied, not to the first sheet as in FIG. 4C, but to the third sheet stacked onto the first and second sheets.

It can be seen from FIGS. 4A-I that the fixing device 7 is always stationary during the process for producing dividing elements according to the invention. The holding device with the sheet retained thereon or the sheets stacked on this sheet moves back and forth across the longitudinal axis of this fixing device 7 during the application of the contact strips and can also be moved sideways parallel to the longitudinal axis of the fixing device, the left-hand and right-hand half of the topmost sheet respectively thereby alternately being provided with contact strips.

In FIG. 5 a plan view from above is seen of a dividing element 1 which is erected, suspended or stretched, and optionally fixed, fully unfolded or stretched in a transport container 2. Seen in plan view from above, the transport container 2 is substantially rectangular in shape, wherein the area of the interior of the transport container 2 is defined by the dimensions X and Y. The erected, suspended, or stretched dividing element 1 extends (perpendicular to the surface of its sheets) over this area XY of the interior of the transport container 2. This dividing element 1 is thus dimensioned such that the dividing element 1 introduced into the transport container 2 forms the desired chambers. In the case shown here, X is chosen to be approximately ¼ smaller than Y. Accordingly, the length of the sheets of the folded-up or slackened dividing element 1 is less than Y here. This has the advantage that the unloaded dividing element 1 can be stored or transported pushed together in the transport container 2, with no need to roll up or bend the dividing element 1. In this way, several pushed-together dividing elements 1 can be stored or transported in one transport container 2 in space-saving manner. If the chosen width of the sheets is also such that it is less than X, a pushed-together dividing element extends according to the present invention at most over a surface XY and can correspondingly be stored or transported lying on the surface XY of the interior of a transport container (not shown).

A plan view from above of a multichamber dividing element 1 with loop surface 9 of a Velcro strip fastener provided in sections is shown in FIG. 6 b). The sections are provided on an outer sheet 3 of the dividing element 1 and are arranged substantially central between the contact surfaces 4, 4′. A top view of the corresponding strip-shaped Velcro strip fastener hook surface 10 which is provided for securing the dividing element 1 on the inside of a transport container (not shown) is shown in FIG. 6 a). Markings 11 are provided on the hook-side Velcro tape 10 which show the points on the Velcro tape 10 which are to be connected to the loop-side sections 9 of the dividing element 1 from FIG. 6b). A plan view from above of the multichamber dividing element 1 connected to the inside wall 12 of the transport container 2 is shown in FIG. 6 c), wherein hook surface 10 and loop surface 9 form the Velcro strip fastener.

In summary it is to be noted for all the shown figures that a person skilled in the art immediately recognizes the schematic nature of the drawings, with the result that when carrying out the present invention he does not feel bound for example to such precise dimensions, size ratios and stack thicknesses as are shown in the figures. The corresponding advantageous dimensions, size ratios and stack thicknesses follow from the respective requirements which for the most part depend on the condition of the cargo and the materials used in the production of dividing elements according to the invention.

1.-25. (canceled)

26. A Multichamber dividing element for transport containers, comprising:
several sheets stacked horizontally or vertically, wherein adjacent sheets are connected to each other via common contact surfaces at defined intervals;
each of the sheets made of flexible material; and
common contact surfaces of two given, directly connected sheets are arranged offset in a sheet plane vis-à-vis the contact surfaces of one of these sheets with a respective next sheet (if present), wherein the dividing element can be erected, suspended or stretched such that it has flexible chambers when erected, suspended or stretched.

27. The dividing element according to claim 26, wherein the common contact surfaces are substantially continuous contact strips which are arranged parallel at defined intervals and extend substantially over one dimension of the sheet surface.

28. The dividing element according to claim 27, wherein the contact strips of one contact strip plane between two given, directly connected sheets are arranged offset in the sheet plane across a longitudinal extension of the contact strips vis-à-vis the contact strips of a contact strip plane of one of these sheets with a respective next sheet (if present).

29. The dividing element according to claim 28, wherein the contact strips of two adjacent contact strip planes are arranged offset by half a distance between the contact strips of one plane.

30. The dividing element according claim 26, wherein the sheets of flexible material are connected to one another via the common contact surfaces by gluing, sewing, welding or attaching profiles.

31. The dividing element according to claim 26, wherein at least some of the sheets are releasably connected to one another to form the common contact surfaces by double-sided adhesive tape, Velcro fastening, buttons, pushbuttons or hooks and eyes.

32. The dividing element according to claim 26, wherein the flexible material includes flexible plastic and elastic materials.

33. The dividing element according to claim 32 wherein the flexible materials including flexible materials that do not become electrostatically charged.

34. The dividing element according to claim 26, wherein the flexible material includes foils, nonwovens, laminates, coated woven fabrics, woven fabrics and interlaid scrim.

35. The dividing element according to claim 34 wherein the flexible material includes industrial-grade textiles whose textile meshes are arranged slidable in and out of one another.

36. The dividing element according to claims 26, wherein the dividing element is watertight or liquid-resistant.

37. The dividing element according to claim 26, wherein the dividing element can be repeatedly erected, suspended or stretched and folded up again and is continually recyclable.

38. The dividing element according to claim 26, wherein the chambers of the dividing elements which lie between two given sheets are substantially the same.

39. The dividing element according to claim 26, wherein the chambers are variable in shape.

40. The dividing element according to claim 39 wherein the chambers are any of circular, elliptical, rhomboidal or rectangular.

41. The dividing element according to one claim 26, wherein the dividing element can be erected or suspended in a transport container, or stretched in the latter, wherein the dividing element can be permanently fixed by gluing or tacking, via nails, screws or rivets and/or releasably fixed via double-sided adhesive tape, Velcro fastening, buttons, pushbuttons or hooks and eyes.

42. The dividing element according to claim 41, wherein the hook side or the loop side of a Velcro fastening is provided sectionwise on an outer sheet of the dividing element, wherein the sections are arranged substantially central relative to two adjacent contact surfaces which an outer sheet has with its respective adjacent sheet.

43. The dividing element according to claims 26, wherein the dividing element can be erected, suspended or stretched in a corresponding transport frame or transport container, wherein the interior of the transport frame or transport container is divided into several chambers by the dividing element.

44. The dividing element according to claim 43, wherein if the interior of the transport container or frame has a substantially rectangular starting surface measuring X by Y, and has an internal dimension Z substantially perpendicular to this surface, the width of the sheets of the dividing element is substantially less than or equal to Z, and the dividing element when erected, suspended or stretched extends perpendicular to the sheet surface over a surface that corresponds substantially to the surface X by Y or is slightly smaller than same.

45. The dividing element according to claim 44, characterized in that X is approximately ⅕ to ⅓ shorter than Y and the length of the sheets of the pushed-together or slackened dividing element is less than Y, and in that the width of the sheets is preferably less than X.

46. The dividing element according to claim 26, characterized in that reinforcements are provided in at least one dimension in the sheet plane.

47. The dividing element according to claim 46 wherein reinforcements are provided in two dimensions, wherein fibre materials and/or profiles of plastic or other at least semi-rigid materials are provided worked into the sheets or attached to the sheets as reinforcements.

48. A method of producing a multichamber dividing element for transport containers, comprising:
connecting two sheets of flexible material via common contact surfaces at a large number of points distributed over surfaces of the sheets by gluing, sewing, welding or attaching profiles; and
subsequently stacking areally a plurality of additional sheets onto the aforesaid two sheets of flexible material and connecting each such further sheet onto a sheet onto which it is stacked via common contact surfaces at a large number of pints distributed over surfaces of the sheets by gluing, sewing, welding or attaching profiles.

49. The method of claim 48, and further including:
a) applying adhesive in a pointwise application at defined intervals to a top of a first one of the sheets of flexible material,
b) laying a one of the sheets sheet of flexible material dimensioned corresponding to the first sheet onto the top of the first sheet;
c) applying adhesive in a pointwise application at defined intervals to the top of the second sheet, wherein the adhesive dots are applied offset vis-à-vis adhesive dots on the first sheet applied by the point application of adhesive,
d) laying a third one of the sheets of flexible material, dimensioned corresponding to the previous sheets, onto the top of the second sheet;
e) applying adhesive in a pointwise application to the top of the third sheet at defined intervals, wherein the adhesive dots are applied offset vis-à-vis the adhesive dots on the second sheet; and
f) stacking of any number of further ones of the flexible sheets onto the aforesaid flexible sheets and applying adhesive in a pointwise application to the top of each of the further ones of the flexible sheets, the adhesive dots of each of the further ones of the flexible sheets offset vis-à-vis the adhesive dots of the flexible sheet on which it is stacked, and laying of a last one of the flexible sheets sheet onto the last but one of the flexible sheets provided with adhesive dots.

50. The method of claim 48, and further including:
a) laying of a second one of the sheets sheet, dimensioned corresponding to a first one of the sheets, onto a top of the first sheet;
b) pointwise welding or sewing of the first sheet to the second sheet at defined intervals;
c) laying of a third one of the sheets, dimensioned corresponding to the first and second sheets, onto the top of the second sheet;
d) pointwise welding or sewing of the second sheet to the third sheet at defined intervals, wherein the welds or seams are offset vis-à-vis the welds or seams from step b; and
d) repeating steps c and d until a desired number of sheets are welded or sewn together.

51. The method according to claim 48 wherein the contact surfaces of an nth one of the sheets sheet are arranged like the contact surfaces of an sheet previous the nth sheet.

52. The method according to claim 48 wherein a fixing device for gluing, welding, sewing or attaching profiles of the sheets is stationary, and a holding device for retaining the sheet or the stacked sheets can be moved back and forth across the longitudinal axis of the fixing device and sideways parallel to the longitudinal axis of the fixing device.

53. A method of transporting or storing loads, comprising:
placing the loads in a transport container having a multichamber dividing element, the multichamber dividing element including a plurality of sheets stacked horizontally or vertically, wherein adjacent sheets are connected to each other via common contact surfaces at defined intervals;
transporting the transport container if transporting the loads; and
storing the transport contained if storing the loads.

54. The method of claim 53 wherein the loads are one or more of heavy, sharp-edges, moist or liquid-excluding loads.

55. The method of claim 53 wherein the loads are articles with sensitive surfaces.

56. The method of claim 53 wherein the articles with sensitive surfaces include articles with varnished surfaces, car parts, glass items.
